(19) United States
(12) Patent Application Publication
(10) Pub. No.: US 2007/0156486 A1
(43) Pub. Date: Jul. 5, 2007

(54) Multiple concurrent workflow persistence schemes

(75) Inventors: Andres Sanabria, Sammamish, WA (US); Constantin Mihai, Bellevue, WA (US); Nikhil Kothari, Sammamish, WA (US); Israel Hilerio, Kenmore, WA (US); Michael Harder, Bellevue, WA (US); Paul E. Maybee, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Remond, WA (US)

(21) Appl. No.: 11/321,789

(22) Filed: Dec. 29, 2005

(51) Int. Cl. G06F 9/46

(52) U.S. Cl. 705/8

(57) ABSTRACT

Systems and methods that supply workflow management and workflow interaction with a plurality of persistence stores via employing a routing persistence service and an association lookup component. The routing persistence service routes and/or assigns each workflow instance to a corresponding persistence store, and the association lookup component manages caching associations between the workflow instance(s) and the plurality of persistence services. Accordingly, the subject innovation facilitates an extensible and/or pluggable mechanism for concurrent usage of multiple concrete implementations of a generic abstract workflow provider.

### BACKGROUND

Typically all software employed in enterprises today support business processes. Some of such processes are entirely automated, relying solely on communication among applications, while others rely on people to initiate the process, approve documents the process uses, resolve any exceptional situations that arise, and more. In either case, it is common to specify a discrete series of steps known as a workflow that describes the activities of the people and software involved in the process. Once such workflow has been defined, an application can be built around that definition to support the business process.

Put differently, workflow generally is the flow of information and control in organizations. Businesses continually strive to define, document, and streamline such processes in order to effectively compete. In a business setting, these processes include sales and order processing, purchasing tasks, inventory control and management, manufacturing and production control, shipping and receiving, accounts payable, and the like.

Computer systems and associated software now provide tools with which businesses and other organizations can improve their workflow. Software tools can be used to model business workflow processes or schedules and identify inefficiencies and possible improvements. In addition, where a process involves exchanging data between people, departments, plants, or even between separate companies, computer systems and networks can be used to implement such exchanges. Such systems and software tools are further able to implement large-scale computations and other data or information processing that are typically associated with business related information.

Accordingly, workflow management includes the effective management of information flow and control in an organization's business processes, wherein automation of such information processing has led to many efficiency improvements in the modem business world. Moreover, such automation of workflow management is now allowing businesses and other organizations to further improve performance by executing workflow transactions in computer systems, including global computer networks, such as the Internet.

A typical workflow-based application often requires a plurality of conditions to be satisfied. For example, one such condition is the ability to make decisions based on business rules. Such can include simple rules, (e.g., like as a yes-or-no decision based on the result of a credit check), and more complex rules, (e.g., the potentially large set that must be evaluated to make an initial underwriting decision.) Another requirement is communication with other software and other systems outside the workflow. For example, an initial request can be received from one part of the application, while some aspects, (e.g., contacting a credit service) can require communication using other web services or technologies. A further condition to be satisfied is the proper interaction of the workflow with users. For example, the workflow should typically be able to display a user interface itself or interact with human beings through other software. Moreover, the ability to maintain state throughout the workflow's lifetime is another condition that needs to be satisfied. Accordingly, creating and executing a workflow in software poses unique challenges.

For example, some business processes can take hours, days, or weeks to complete, and maintaining information about the workflow's current state for such length of time is demanding. Moreover, such kind of long-running workflow is also typically required to communicate with other software in a non-blocking way, and an asynchronous communication can pose difficulties. At the same time, while modeling fixed interactions among software is relatively straightforward, consumers tend to continuously require additional flexibility, such as the ability to change a business process on-the-fly. Handling diverse applications can further add to the complexities involved in workflow creation and management.

Many applications for workflow tools are internal to a business or organization. With the advent of networked computers having modems or other type communications links, computer systems at remote locations can now communicate easily with one another. Such enhanced communication allows computer system workflow applications to be used between remote facilities within a company. An example would include forwarding a customer order from a corporate headquarters to a remote field sales office for verification by the appropriate sales person, and returning a verification to the headquarters. Workflow applications also can be of particular utility in processing business transactions between different companies. In a typical application, two companies having a buyer-seller relationship may desire to automate the generation and processing of purchase orders, product shipments, billing, and collections.

For example, an application targeting a specific problem, such as customer relationship management (CRM), or a specific vertical market, such as financial services, can be built around a workflow. Such kind of application commonly implements a number of different business processes. Building the logic that drives those processes on a common workflow foundation such as Windows Workflow Foundation can make the application faster to build, quicker to change, and easier to customize. Moreover automating such processes can result in significant efficiency improvements, which are not otherwise possible.

However, such inter-company application of workflow technology requires co-operation of the companies and proper interfacing and proper persistence service implementation of the individual company's existing computer systems and applications. In addition, host applications interacting with such workflows are typically forced to employ the same persistence mechanisms. Such an approach does not provide flexibility, and hence is not feasible when different applications require interaction with different back ends.

Therefore, there is a need to overcome the aforementioned exemplary deficiencies associated with conventional systems and devices.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject innovation provides for systems and methods that supply workflow management and workflow interaction with a plurality of persistence services implementations/stores via employing a routing persistence service and an association lookup component. The routing persistence service routes and/or assigns a workflow type to a persistence store, wherein data for the state of the workflow (such as property values, current activity, execution sequence, suspension information, time to resume, metadata, time stamps, and the like) is saved to the persistent store. Accordingly, the routing persistence service integrates persistence related functionalities into the runtime of the workflow, wherein each workflow instance can be registered with a corresponding persistence service implementations. Moreover, such routing persistence service interacts with the association lookup component to manage caching associations between the workflow instance(s) and the plurality of persistence service implementations. Accordingly, regardless of a typical limitation of a conventional workflow runtime to interact with one persistence service, the subject innovation enables more than one persistence services to accommodate, and/or interact with, the workflow. Furthermore, such system can facilitate an extensible and/or pluggable mechanism for concurrent usage of multiple concrete implementations of a generic abstract workflow provider.

For example, initially the routing persistence service can be registered, and subsequently verified by a host service associated with the workflow(s). Based on the workflow provider's type, desired persistence service implementation can then be selected (e.g., programmatically and/or via a configuration setting), and the workflow created. Next, the workflow can be assigned identification to be associated with a desired persistence service implementation such as in-memory, relational data store, XML/text file, and the like, wherein different types of workflow can be assigned to (and/or interact with) different persistent stores.

In a related methodology in accordance with an aspect of the subject innovation, the host application can access a running workflow, by initially verifying a routing persistence service associated with the workflow engine and/or runtime. Subsequently, based on the workflow instance identification (e.g., ID number), the corresponding persistence service can call load method and/or call save method via the association lookup component (e.g., a tabular arrangement). The workflow instance can then be accessed (e.g., via the host application).

According to a further aspect of the subject innovation for saving an instance of the workflow, initially a routing persistence service that is associated with the workflow is verified. Subsequently and based on the workflow instance, a workflow state representation is generated for such workflow instance. Data associated with such workflow state representation can then be saved to a persistence state.

In a related methodology, to load an instance of the workflow, a routing persistence service is initially verified, and access to a corresponding persistence store is provided. Subsequently, workflow instance state representation is obtained from such corresponding persistence store. Such representation is then converted to workflow instances, and provided to the host application, for example.

According to a further aspect of the subject innovation, the workflow instance in a persistence store can be unregistered with the association lookup component. For example, upon completion of a workflow, an association between the workflow instance identification and the routing persistence service is unregistered (e.g., from the in-memory table association.)

By accommodating/interacting with a plurality of persistence stores, the subject innovation enhances the workflow foundation model to enable different types of applications to communicate with different back ends. For example, a Customer Relationship Management (CRM) can interact with a customer database, while another custom made application that leverages the workflow employs another persistent service implementation.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates an exemplary system diagram of a workflow having a routing persistence service that interacts with a plurality of persistence stores in accordance with an aspect of the subject innovation.

FIG. 2 illustrates a block diagram of an association lookup component that interacts with the plurality of persistence service implementations.

FIG. 3 illustrates a methodology of registering/creating a new workflow in accordance with an aspect of the subject innovation.

FIG. 4 illustrates a flowchart for registration of a routing persistence service provider with a workflow run-time.

FIG. 5 illustrates a methodology of accessing a running workflow in accordance with an aspect of the subject innovation.

FIG. 6 illustrates data store interaction for loading instances of the workflow.

FIG. 7 illustrates data store interaction for saving instances of the workflow.

FIG. 8 illustrates un-registering associations for a completed workflow according to one aspect of the subject innovation.

FIG. 9 illustrates an exemplary environment for implementing various aspects of the subject innovation.

FIG. 10 is a schematic block diagram of an additional-computing environment that can be employed to implement a workflow with routing persistence service of the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system”, “service” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The term computer program as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

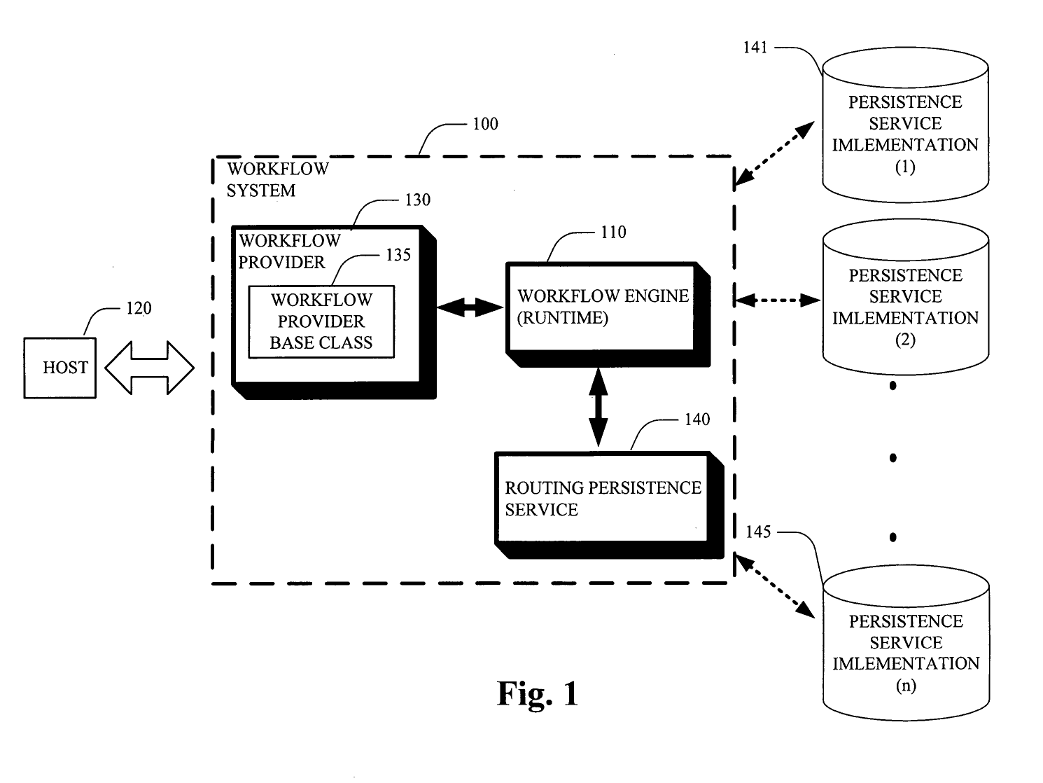

Turning initially to FIG. 1, a block diagram for a workflow system 100 is illustrated, which employs a routing persistence service 140 to enable a workflow management and workflow interaction with a plurality of persistence services implementations/stores 141-145 (1 thru n, where n is an integer.) The workflow can model a human or system process that is defined as a map of activities. An activity is an act in a workflow, and is the unit of execution, re-use, and composition for a workflow. The map of activities expresses rules, actions, states, and their relation. Typically, the workflow runs via the workflow engine/runtime 110, and the workflow runtime requires an external application to host it, according to a few rules, as depicted by the host 120.

The host 120 interacts with Workflow Provider 130 through the Workflow Provider Base Class 135. In addition, the host 120 can be responsible for a number of additional and critical aspects, such as the creation of one or more processes, marshaling of calls between various components as needed for proper execution of the workflow; and setup of isolation mechanisms. In addition, the host 120 can create multiple processes to take advantage of multiple Central Processing Units (CPUs) in a machine for scalability reasons, or to run a large number of workflow instances on a farm of machines. The host 120 can further control the policies to apply when a workflow is subject to a long wait, listen for specific events and communicate them to a user or administrator, set timeouts and retries for each workflow, expose performance counters, and write log information for debugging and diagnostic purposes.

A workflow associated with the workflow system 100 can communicate with the outside world through a service established specifically for that purpose, wherein such service can raise events that event-driven activities inside the workflow will hook up. Likewise, the service exposes public methods for the workflow to call and send data to the host. The Workflow can be defined in the form of a schedule for execution in a computer system, for example. A schedule can include a set of actions having a specified concurrency, dependency, and transaction attributes associated therewith. Each schedule has an associated schedule state, which includes a definition of the schedule, the current location within the schedule, as well as active or live data and objects associated with the schedule. Within a schedule, transaction boundaries can exist based on groupings of actions. In this regard, a transaction can encompass individual actions, or transactions, or groups thereof. As discussed further hereinafter, actions may be grouped into sequences, which are executed in serial fashion, as well as tasks in which the actions are executed concurrently. Based on the groupings, therefore, concurrency attributes can be resolved for the actions and transactions within a schedule.

Typically, workflows maintain state while they execute. Such state can include both data and property values as defined by the workflow developer, and the internal execution state. In addition, execution state can include the current activity along with the execution sequence, and any relevant suspension information (e.g., time to resume the workflow if a delay suspension was introduced). Moreover, the metadata associated with the execution sequence can be tracked (e.g., time stamps of activity execution), wherein such information can be used for later analysis of executed workflows.

All this information should typically be saved to some persistent store 141-145. The workflow system 100 of the subject innovation can employ the WorkflowProvider 130 to abstract the interaction underlying storage with a common Application Program Interface (API), wherein workflows can be identified by a combination of their name (as defined by the workflow developer), and by a unique identifier, for example. Thus, the WorkflowProvider can allow creating new instances of workflows, loading serialized instances given the identifier, saving workflow instances, and enumerating existing workflows. An application with multiple workflows, in accordance with an aspect of the subject innovation can choose different provider types/implementations for different workflow instances. This allows workflows to use different persistence semantics, or different database back-ends for example.

As illustrated in FIG. 1, the routing persistence service 140 routes and/or assigns a workflow instance to a persistence store selected from a plurality of persistence stores 141-145. As such, data pertaining to the state of the workflow (such as property values, current activity, execution sequence, suspension information, time to resume, metadata, time stamps, and the like) is saved to the persistent store. Accordingly, the routing persistence service 140 integrates persistence related functionalities into the runtime of the workflow, wherein each workflow instance can be registered with a corresponding persistence service. Moreover, such routing persistence service interacts with the association lookup component (not shown), as described in detail infra, to manage caching associations between the workflow instance(s) and the plurality of persistence services. Accordingly, regardless of a typical limitation of a conventional workflow runtime to interact with one persistence service, the subject innovation enables more than one persistence services to accommodate (and/or interact with) the workflow.

The following provides for an exemplary Routing Persistence Service provider, according to a particular aspect of the subject innovation:

public class RoutingPersistenceService :

StatePersistenceService

{

public static void Register (

Guid workflowInstanceId,
IPersistenceService persistenceService) { }

public static void Unregister (Guid

workflowInstanceId) { }

public static IPersistenceService

GetPersistenceService (

Guid workflowInstanceId) {

//--------------- StatePersistenceService Methods
public override void SaveWorkflowInstanceState(

Activity rootActivity, bool unlock)

{

IPersistenceService persistenceService =

GetPersistenceService(
(Guid) rootActivity.GetValue(

WorkflowInstance.WorkflowInstanceIdProperty));
persistenceService.SaveWorkflowInstanceState(rootActivity,

unlock);

}
public override void UnlockWorkflowInstanceState(

Activity rootActivity)

{

IPersistenceService persistenceService =

GetPersistenceService((Guid)

rootActivity.GetValue(
WorkflowInstance.WorkflowInstanceIdProperty));
persistenceService.UnlockWorkflowInstanceState(

rootActivity);

}
public override Activity

LoadWorkflowInstanceState(

Guid instanceId)

{

IPersistenceService persistenceService =

GetPersistenceService (instanceId);

return

persistenceService.LoadWorkflowInstanceState(

instanceId);

}
public override void SaveCompletedContextActivity(

Activity activity)

{

IPersistenceService persistenceService =

GetPersistenceService((Guid)

activity.GetValue(
WorkflowInstance.WorkflowInstanceIdProperty));
persistenceService.SaveCompletedContextActivity(activity);

}
public override Activity

LoadCompletedContextActivity(

Guid scopeId, Activity outerActivity)

{

IPersistenceService persistenceService =

GetPersistenceService((Guid)

outerActivity.GetValue(
WorkflowInstance.WorkflowInstanceIdProperty));

return

persistenceService.LoadCompletedContextActivity(

scopeId, outerActivity);

}

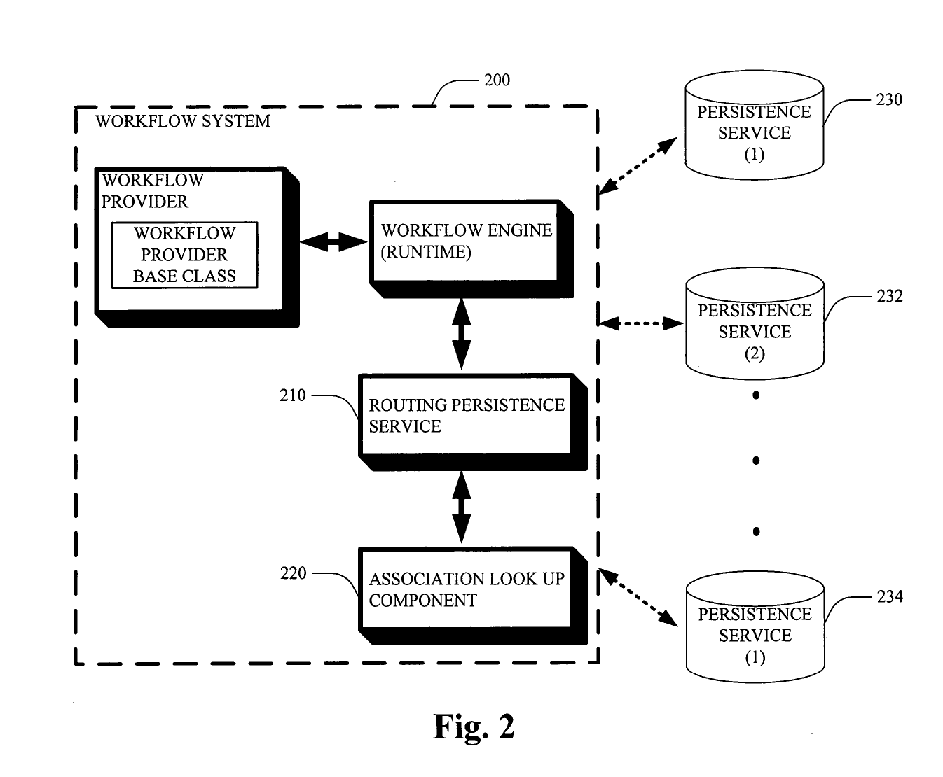

Referring now to FIG. 2 there is illustrated a block diagram of a routing persistence service 210 that interacts with the association lookup component 220 to manage caching associations between the workflow instance(s) and the plurality of persistence services 232-234. Accordingly, the workflow can be assigned identification to be associated with a desired persistence store such as in-memory, relational data store, XML text files, and the like, wherein individual workflows can be assigned to (and/or interact with) different persistent stores. The association lookup component 220 can receive property information (e.g., attribute(s)) associated with a workflow instance for a lookup thereof. The lookup component 220 can include a lookup list (e.g., a tabular form) that correspond a workflow instance to a persistence service(s).

The lookup component 220 further obtains/employs information associated with the workflow instance (e.g., DataType, database and/or object). The information can include, for example, property(ies) associated with the workflow instance. Based, at least in part, upon the property information and the information associated with the workflow instance, the lookup component can then generate a configured lookup control (e.g., ID, display values and metadata required to associate them). As such, the property values, current activity, execution sequence, suspension information, time to resume, metadata, time stamps, and the like) is saved to a corresponding persistent store 230-234. Moreover, a persistent store can be selected based on a workflow ID. A query can be submitted to a workflow store to find matching workflows based on a query criteria.

In accordance with an aspect of the subject innovation, the system 200 incorporates the persistence of the metadata required to associate an ID with a workflow instance and a persistence service implementation. For example, data for the state of the workflow and the workflow instance can include property values, current activity, execution sequence, suspension information, time to resume, metadata, time stamps, and the like, which is saved to the persistent store. Based on the workflow provider type and workflow instance, desired persistence service implementation 230-234 can then be selected (e.g., programmatically and/or via configuration setting, page configuration using tags, and the like), and the workflow instance persisted therein. By accommodating/interacting with a plurality of persistence stores 230-234, the workflow foundation model is enhances to enable different types of applications to communicate with different back ends. For example, a Customer Relationship Management (CRM) can interact with a customer database, while another custom made application that leverages the workflow employs another persistent service implementation.

The association lookup component 220 can employ dependencies (e.g., from an identifier source to a target workflow instance) by tracing from identifiers to workflow instances via a mapping. For example, a hierarchy match list can be generated to correspond the identifications with the workflow instances. As such, a mapping definition tool can enable graphically specifying data transformations from the identifiers (source) to the workflow instances (target).

As explained earlier, the association lookup component 220 obtains identification information associated with the workflow instance (e.g., DataType, database and/or object). The information can include, for example, property(ies) associated with the workflow instance. Based, at least in part, upon the property information and the information associated with the workflow instance, the association lookup component 220 can connect to a respective persistence service implementation and/or data store to obtain workflow state representation 230-234. Such workflow state representation can be subsequently converted to workflow instance for a return thereof.

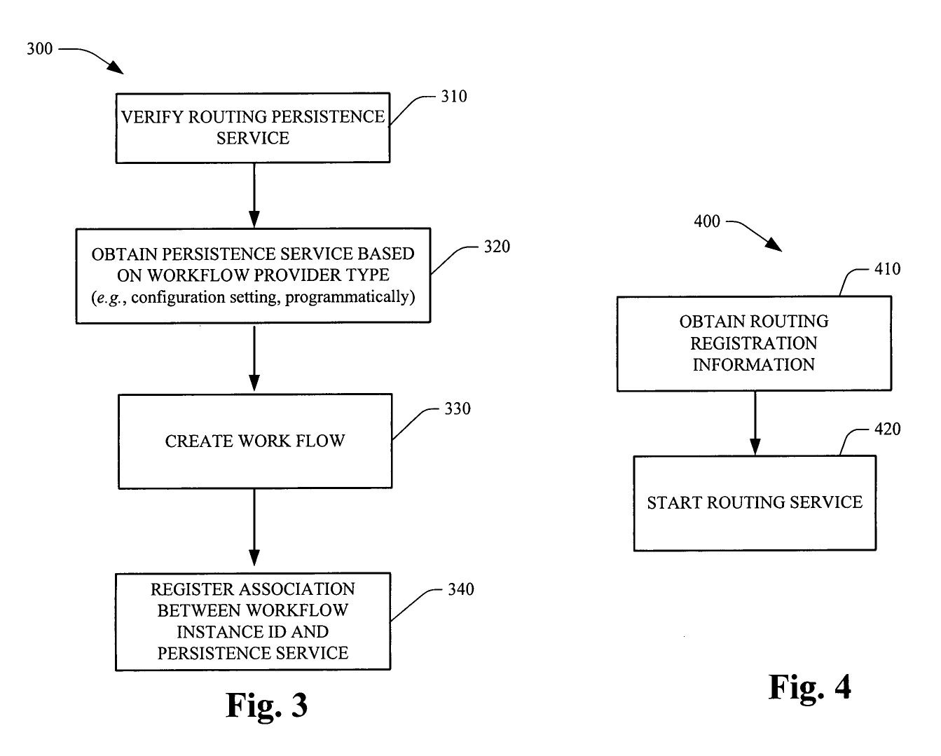

FIG. 3 illustrates an exemplary flowchart 300 of creating a workflow and a registration thereof with a persistence service implementation, according to an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 310, a routing persistence service associated with the workflow system is verified. Such routing persistence service can route and/or assign a workflow instance to a persistence store selected from a plurality of persistence stores. Accordingly, data pertaining to the state of the workflow (such as property values, current activity, execution sequence, suspension information, time to resume, metadata, time stamps, and the like) is saved to the persistent store. Thus, the routing persistence service integrates persistence related functionalities into the runtime of the workflow, wherein each workflow instance can be registered with a corresponding persistence service. At 320, based on the workflow provider type, the persistence service implementation is designated and/or obtained (e.g., programmatically, and/or thru configuration setting.) At 330, the workflow can be created and associated with an identification, wherein such identification is registered between the workflow instance and the corresponding persistence service implementation at 340.

FIG. 4 illustrates an exemplary registration methodology 400 for the routing persistence service by a workflow run time in accordance with an aspect of the subject innovation. Initially, and at 410 information related to routing persistence service is obtained, via web configuration and/or programmatically, for example. Such routing persistence service can then start operation in association with a workflow system, at 420, to create a mapping for registering/un-registering a workflow instance with a persistence service implementation as described in detail infra. It is to be appreciated that there can exist multiple implementations for an association, in accordance with an aspect of the subject innovation. For example, an application with multiple workflows, in accordance with an aspect of the subject innovation can choose different provider implementations for each workflow type. This allows workflows to use different persistence semantics, or different database back-ends. The workflow instance can be serialized into a database or equivalent storage, from which it can be subsequently retrieved, deserialized, and resumed, during a suspension of the workflow. For example, workflows can be suspended for a number of reasons, such as: canceling of an activity execution, inability for an activity to continue execution, a specific delay introduced to postpone subsequent execution, and switching of user context requiring subsequent execution to be carried out by a different user. It is to be appreciated that two workflow instances originating from a same workflow definition (e.g., type/class) can have, or employ different persistent stores.

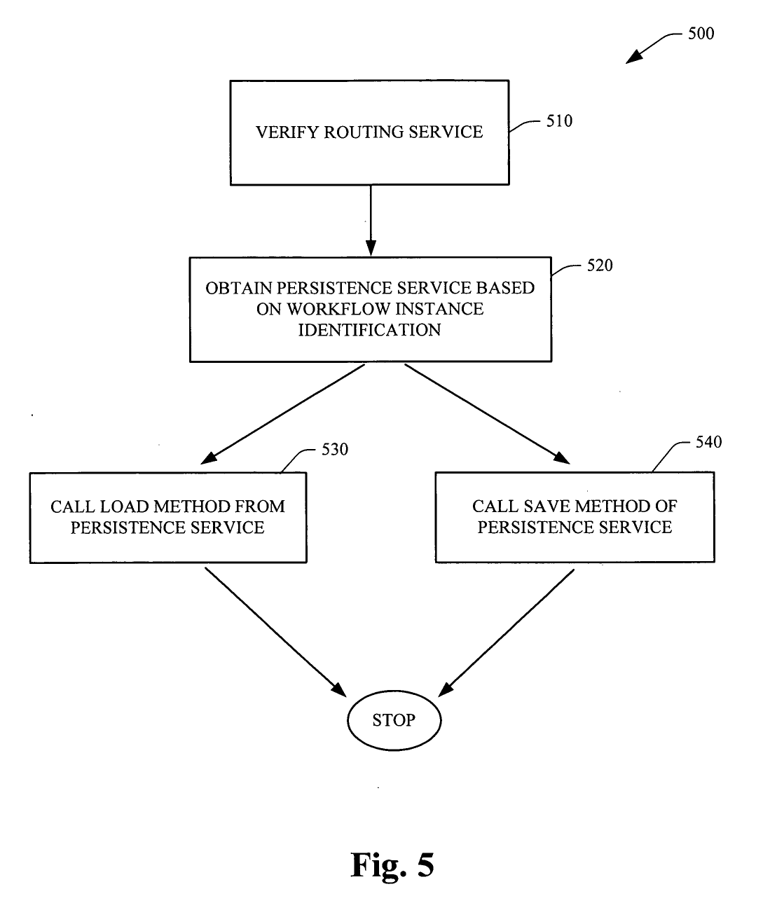

FIG. 5 illustrates a methodology of accessing a running workflow, via a workflow runtime by a host application, in accordance with an aspect of the subject innovation. The host application can access a running workflow, by initially verifying a routing persistence service associated with the workflow engine and/or runtime, at 510. Subsequently, and at 520 based on the workflow instance identification (e.g., ID number), the corresponding persistence service can call load method 530 and/or call save method 540 via the association lookup component (e.g., a tabular arrangement). The workflow instance can then be accessed (e.g., via the host application). By accommodating/interacting with a plurality of persistence stores, the subject innovation enhances the workflow foundation model to enable different types of applications.

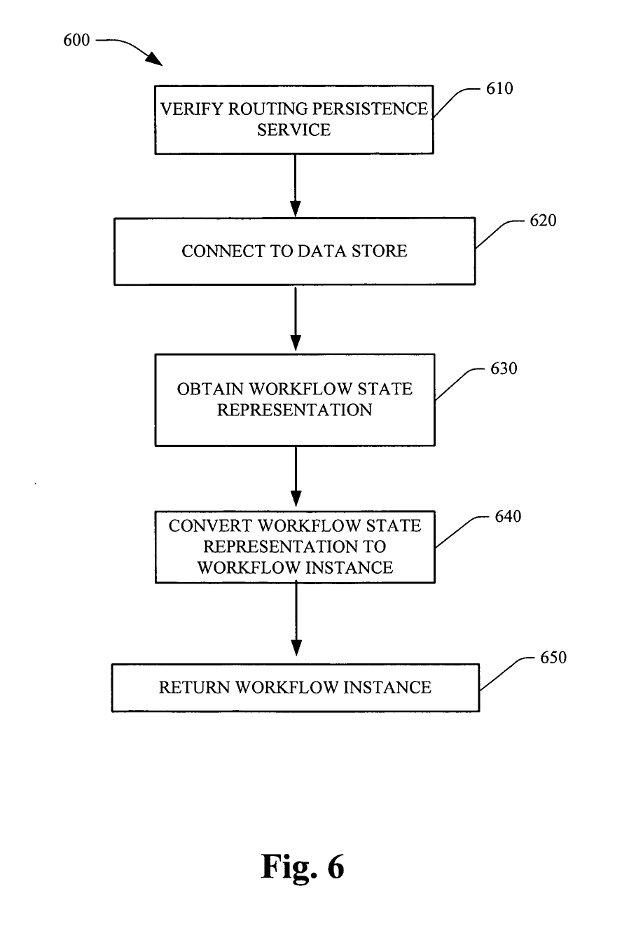

FIG. 6 illustrates a related methodology 600 of loading an instance of the workflow according to act 530 of FIG. 5. As illustrated in FIG. 6, a routing persistence service is initially verified at 610, and access to the persistence store is provided at 620, wherein a workflow instance state representation is obtained from the corresponding persistence store, at 630. Such representation can then be converted to workflow instances at 640. The workflow instance can then be provided to the host application for a manipulation thereof.

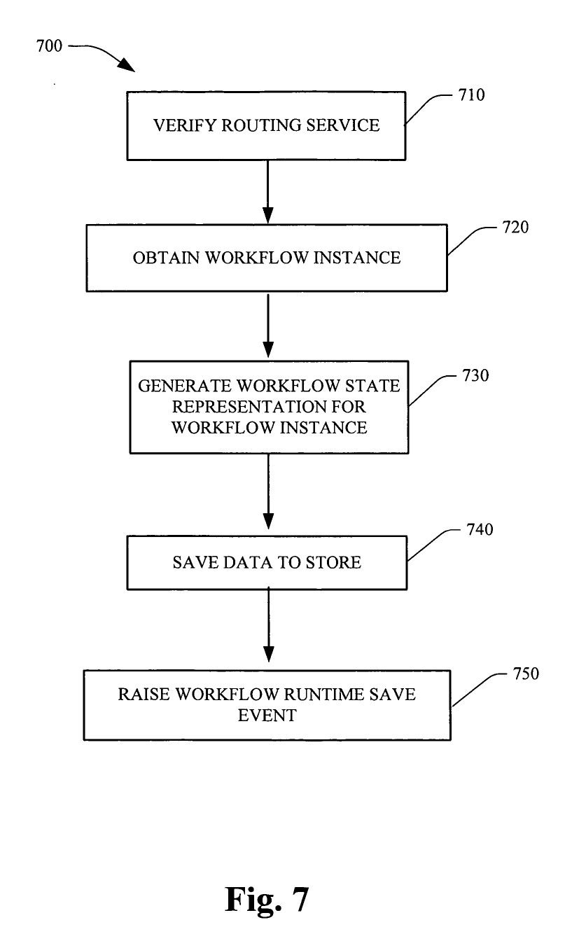

Similarly, FIG. 7 illustrates a methodology 700 for saving an instance of the workflow, as illustrated by act 540 of FIG. 5. Initially a routing persistence service that is associated with the workflow is verified at 710, and the workflow to be saved is obtained is at 720. Subsequently and at 730, a workflow state is generated of representation of the workflow instance. Data related to such representation can then be saved to the data store and/or persistence service implementation at 740. As such and at 750, a workflow runtime save event can be raised, and the workflow instance accessed as described in detail supra.

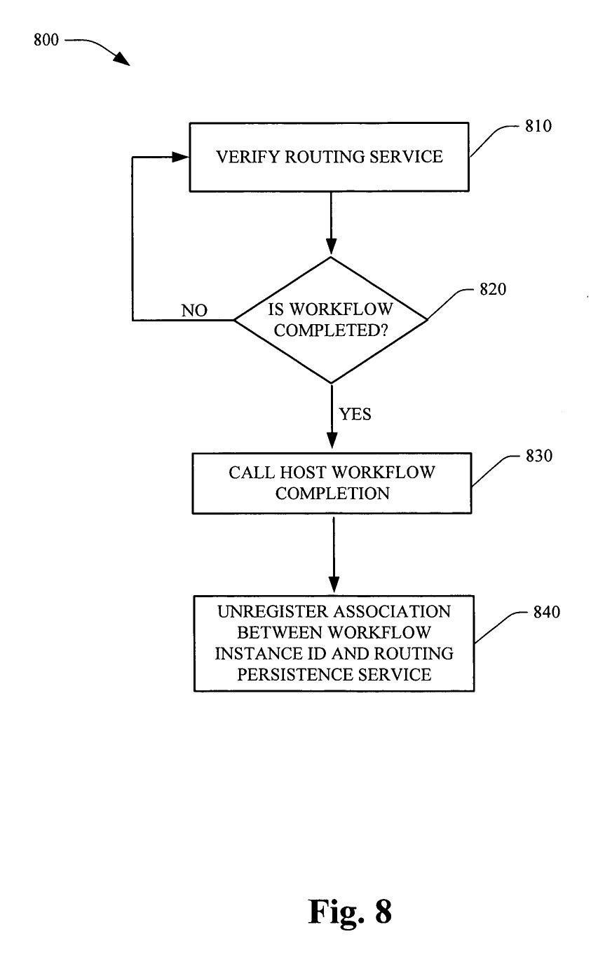

FIG. 8 illustrates a methodology 800 of un-registering a workflow instance in a persistence store with the association lookup component. For example, upon completion of a workflow, an association between the workflow instance identification and the routing persistence service is unregistered (e.g., from the in-memory table association.) Initially and at 810 routing persistence service that is associated with the workflow is verified. Subsequently, and at 820 the workflow is checked for completion. If completed, the host can be so notified at 830. Subsequently and at 840, association between the workflow instance identification and the routing persistence service can be unregistered.

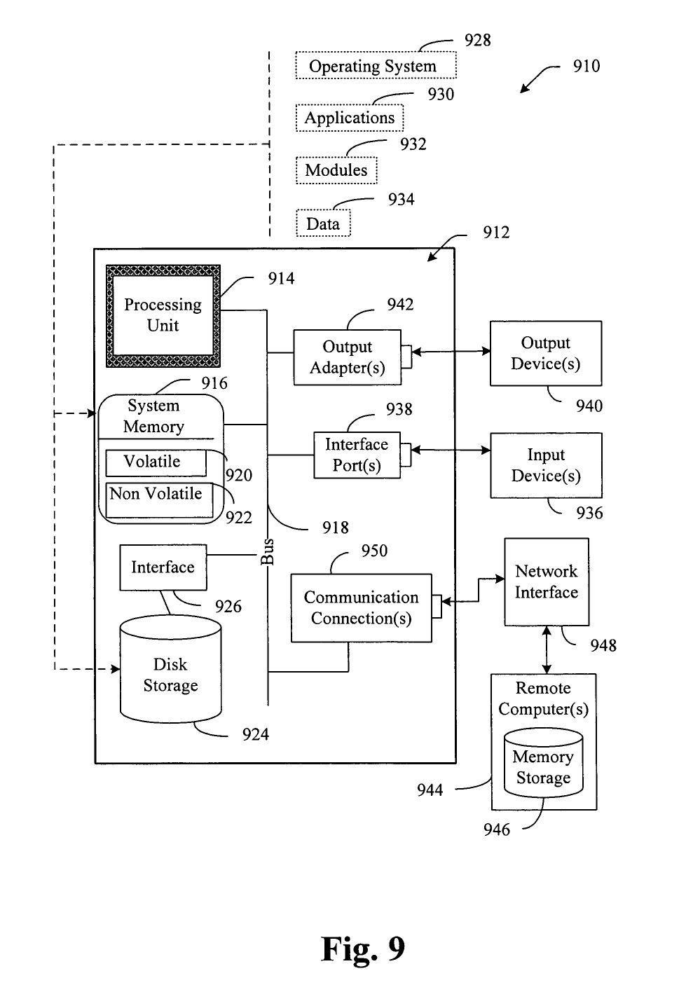

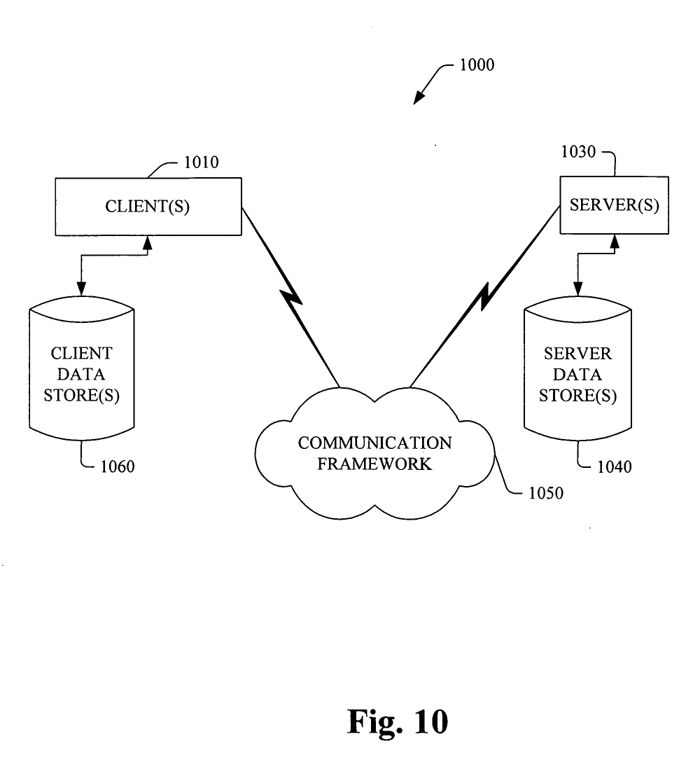

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like that perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed to incorporate a workflow implementation of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
a workflow system having a routing persistence service that routes each workflow instance to a corresponding persistence service implementation, and
a plurality of persistence service implementations, the corresponding persistence service implementation assigned to a workflow type by the routing persistence service.

2. The computer implemented system of claim 1, the workflow system further comprising an association lookup component that manages caching associations between a workflow instance and a persistence service implementation.

3. The computer implemented system of claim 2, the association lookup component further comprising a tabular arrangement.

4. The computer implemented system of claim 2, the association lookup component further comprising a workflow identification arrangement.

5. The computer implemented system of claim 1, the plurality of persistence service implementations comprises at least one of a database, XML/text file and an in-memory storage.

6. The computer implemented system of claim 1 further comprising a workflow provider class that provides for an interaction between a host application and a persistence store.

7. The computer implemented system of claim 2, the workflow instance registerable by the routing persistence service.

8. The computer implemented system of claim 6, the plurality of persistence service implementations accommodate different applications.

9. A computer implemented method comprising the following computer executable acts:
assigning each workflow instance associated with a workflow system to a corresponding persistence service implementation via a routing service provider; and
obtaining a workflow instance from the corresponding persistence service.

10. The computer implemented method of claim 9 further comprising obtaining routing registration information.

11. The computer implemented method of claim 10 further comprising verifying the routing service provider.

12. The computer implemented method of claim 9 further comprising creating a workflow instance.

13. The computer implemented method of claim 12 further comprising registering association between the workflow instance and a persistence service implementation via an identification.

14. The computer implemented method of claim 13 further comprising calling one of a load and save method from the persistence service implementation.

15. The computer implemented method of claim 14 further comprising connecting to a data store associated with the persistence service implementation.

16. The computer implemented method of claim 15 further comprising obtaining a workflow state representation.

17. The computer implemented method of claim 16 further comprising converting the workflow state representation to a workflow instance.

18. The computer implemented method of claim 17 further comprising returning the workflow instance to a host.

19. The computer implemented method of claim 18 further comprising calling a save method of the persistence service implementation.

20. A computer implemented system comprising the following computer executable components:
means for integrating persistence related functionalities for a plurality of data stores into runtime of a workflow; and
means for caching associations between workflow instances and plurality of persistence services.
